(19) United States
(12) Patent Application Publication
(10) Pub. No.: US 2009/0283990 A1
(43) Pub. Date: Nov. 19, 2009

(54) EZ BN green shopping bag with wheels

(76) Inventor: Sandra Louise Graham, Cleveland, OH (US)

Correspondence Address: Sandra Louise Graham, 4505 Pearl Road apt207, Cleveland, OH, 44109-4226, US

(21) Appl. No.: 12/454,102

(22) Filed: May 13, 2009

Related U.S. Application Data
(60) Provisional application No. 61/127,641, filed on May 15, 2008.

(51) Int. Cl. B62B 5/00; A44B 19/00; A45F 5/00; A45C 3/00

(52) U.S. Cl. 280/651; 24/381; 224/191; 150/100

(57) ABSTRACT

The EZ BN GREEN SHOPPING BAG WITH WHEELS, is a lightweight, easy to carry, rolling, re-usable mechanical machine. It is particularly suited for those in search of a less taxing, less strenuous way to transport groceries on foot, while simultaneously gaining good cardio exercise.

### CROSS-REFERENCE TO RELATED APPLICATIONS

The non provisional utility patent application for the EZ BN GREEN SHOPPING BAG WITH WHEELS claims the benefit of the prior filed provisional patent application Ser. No. . . .

U.S. Application No. 61/127,641

Confirmation Number 5236

Filing Date May 15 2008

Name of Applicant Sandra Louise Graham

Title of invention EZ BN GREEN SHOPPING BAG WITH WHEELS

Foreign Filing License Granted May 22, 2008

Country Code and Number of Priority Application used for filing under The Paris Convention is U.S. 61/127,641

### STATEMENT REGARDING FEDERALLY SPONSORED RESEARCH OR DEVELOPMENT

No federal funds were used in the development of this invention

### REFERENCE TO SEQUENCE LISTING A TABLE OR A COMPUTER PROGRAM LISTING COMPACT DISC APPENDIX

Not Applicable

### BACKGROUND OF THE INVENTION

What has been discovered is a new and useful process for carrying items on foot, specifically groceries. The rolling EZ BN GREEN SHOPPING BAG WITH WHEELS is a new and useful improvement to the handheld paper, plastic or cloth shopping bag or cumbersome metal personal shopping cart.

EZ BN GREEN SHOPPING BAG WITH WHEELS allows the user to pull rather than carry the items it contains.

The shopping bag on wheels with connecting straight rails, can be stored in an accompanying marsupial handbag, totebag or CartGoPants pocket. The prior art can burden the user with excess baggage when not in use.

The present art allows the user to transport heavy, bulk items with out the stress and strain carrying paper, plastic or handheld cloth shopping bags may cause.

EZ BN GREEN SHOPPING BAG WITH WHEELS is designed to provide more support for the items it holds, so purchased items are less likely to end up on the ground.

### BRIEF SUMMARY OF THE INVENTION

An object of the present invention is to provide freedom for the grocery shopper, especially those on foot, from heavy cumbersome plastic, paper or cloth hand carried shopping bags or burdensome metal personal shopping carts.

The SHOPPING BAG WITH WHEELS, is a mechanical machine that need not be lifted. Instead the shopper can roll groceries along while walking and eliminate the stress and strain associated with the prior art. The present invention also makes a personal metal shopping cart, hauled empty to the user's destination obsolete.

The shopper's choice of the accompanying marsupial totebag, handbag or CartGoPants provide storage for The SHOPPING BAG WITH WHEELS until ready for use

### BRIEF DESCRIPTION OF THE SEVERAL VIEWS OF THE DRAWING

FIG. 1 A marsupial handbag that stores the shopping bag on wheels in an inside pouch when the shopping bag is not in use.

FIG. 2 A marsupial totebag that stores the shopping bag on wheels in an inside pouch when the shopping bag is not in use.

FIG. 3 The rolling, mechanical shopping bag on wheels with connecting straight rails, shown without attachments

FIG. 4A The choice of the marsupial totebag or the marsupial handbag attached to the shopping bag with wheels to form an upper tier. The upper tier has a zippered bottom that opens to add to the shopping bag's container space. The extendable buckled handle adjusts to the user's height. Snaps secure the shopping bag with wheels to the totebag or handbag, and make the user more hands free, by converting two bags into one.

FIG. 4B The shopping bag on wheels, shown with the accompanying marsupial totebag or marsupial handbag attached.

FIG. 5 CartGoPants with a marsupial pocket or pouch to store the shopping bag on wheels when not in use.

### DETAILED DESCRIPTION OF THE INVENTION

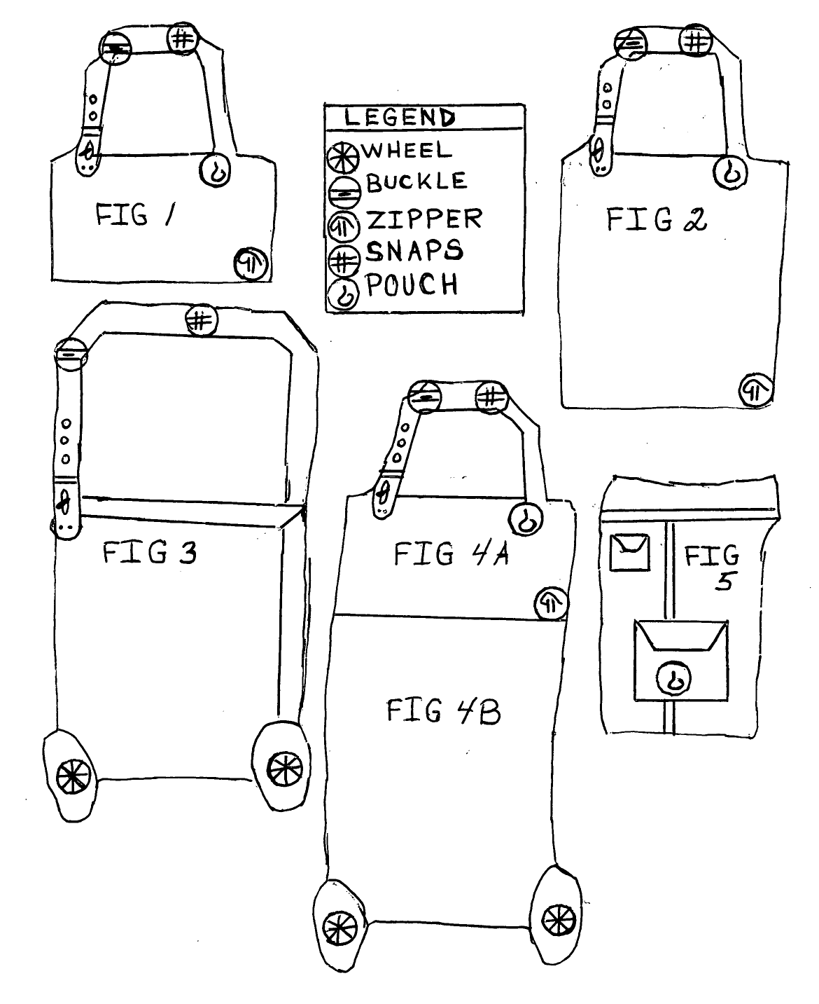

Wheels on connecting straight rails attached to the bottom of a shopping bag is a specific improvement to the prior art and distinguishes the rolling, EZ BN GREEN SHOPPING BAG WITH WHEELS from—FIGS. 3 and 4—other shopping bags. The accompanying marsupial totebag, handbag or CartGoPants provide storage compartments for the shopping bag with wheels vehicle and make the prior art a metal personal shopping cart hauled empty to the user's destination, undesirable.—FIGS. 1, 2, and 5

As an example of the use and benefits of The EZ BN GREEN SHOPPING BAG WITH WHEELS, consider the following documentation by the inventor, that began when the use of public transportation became the agenda.

Carrying heavy, clumsy bags of groceries in paper, plastic or cloth shopping bags, was not easy, whether walking or riding the bus. Plastic bags, that not only cause CO2 issues usually break before you leave the parking lot. Paper bags also tear. Expensive groceries end up on the ground.

Cloth shopping bats are sturdier, but just as burdensome. Hand carrying heavy loads guarantees sore cramped arms, hands neck legs or back. Heart attack or stroke threaten the lives of the elderly.

Personal shopping carts require the user devise a strategy that includes pulling an empty cart to their destination, while hoping for no altering of plans that could halt the day's activities, due to the prior art's limited accessibility.

Knowing there had to be an easier way to do mandatory grocery shopping, the inventor began harvesting plans of action. Wheels have always been a good idea. Making life a little more easy and a little more green with a little more money in your pocket in spired the inventor even further.

The present invention is ideal for those who prefer not to hand carry loads of groceries. Instead they can wheel them in a lightweight vehicle, which adds as a benefit good cardio exercise. The prior art, hand carried plastic, cloth or paper bags, may cause over exertion and further injure the user st knees back arms legs heart etc.

Throw away paper or plastic bags are more likely to add to CO2 landfill gases. The present invention is made from re-usable outdoor canvas and does not contribute to CO2 issues.

The present invention makes walking to shop for groceries an alternative to driving and therefore may help to reduce auto emissions while averting high gas prices.

The prior art a personal metal shopping cart, forces the user to maintain boundaries and therefore requires premeditated use. The present invention can be stored in the go anywhere—accompanying marsupial totebag handbag or CartGoPants, when not in use.

The present art's marsupial totebag and handbag, snap on to the handles of the shopping bag on wheels to form on e container and make the user more hands free.

The totebag and handbag can be unzipped once conjoined with the shopping bag on wheels to form a single opening and add to container space.

In summary the EZ BN GREEN SHOPPING BAG WITH WHEELS saves the user time and money is more health conscious and does not harm the environment.

There may be plans to establish a company and sell EZ BN GREEN SHOPPING BAGS WITH WHEELS. Further modifications of the invention also may occur and all such are deemed to fall within the spirit and scope of the invention as defined by the claims.

1. What I claim as my invention is a rolling, mechanical, shopping bag on wheels, with connecting straight rails.

2. Also claimed are pliable stays or supports in each corner of the shopping bag's sides.

3. Also claimed is a sturdy, folding, supportive, reinforced bottom or floor inside the shopping bag on wheels.

4. Also claimed is a marsupial handbag that stores the shopping bag on wheels in an inside pouch when the shopping bag is not in use.

5. Also claimed is a marsupial totebag that stores the shopping bag on wheels in an inside pouch when the shopping bag is not in use.

6. Also claimed are CartGoPants that store the shopping bag on wheels inside a marsupial pocket or pouch when the shopping bag is not in use.

7. Also claimed are snaps on the handles of the totebag, handbag and shopping bag on wheels that snap together to form a single or conjoined shopping bag on wheels container.

8. Also claimed are zippers i n the bottoms of the totebag and handbag that can be unzipped to provide more container space inside the conjoined totebag and shopping bag with wheels or handbag and shopping bag with wheels.

9. Also claimed are extendable belt and buckle type handles on the shopping bag with wheels, the marsupial handbag and the marsupial totebag that allow height adjustments for the user.
